(19) United States
(12) Patent Application Publication
(10) Pub. No.: US 2012/0048663 A1
(43) Pub. Date: Mar. 1, 2012

(54) MULTISTRUCTURAL SHOCK ABSORBING SYSTEM FOR ANATOMICAL CUSHIONING

(76) Inventor: Kevin McDonnell, Miami, FL (US)

(21) Appl. No.: 13/283,919

(22) Filed: Oct. 28, 2011

Related U.S. Application Data
(63) Continuation-in-part of application No. 12/258,069, filed on Oct. 24, 2008.

(51) Int. Cl. F16F 9/42

(52) U.S. Cl. 188/266

(57) ABSTRACT

A shock absorbing system for impact energy dissipation employs compressible members each having an internal void containing a first working fluid. At least one accumulator is connected to the compressible members through a fluid conduit such that the first working fluid is transferred from the compressible member to the accumulator responsive to compression induced by an impact. A pad and a liner intermediately constrain the compressible members. Resilient structural members are placed intermediate the compressible members to deform responsive to compression of the foot bed induced by foot strike provide both energy dissipation and resilient recovery of the compression cylinders to their uncompressed state.

### REFERENCES TO RELATED APPLICATIONS

This application is a continuation in part (CIP) of application Ser. No. 12/258,069 filed on Oct. 24, 2008 entitled MULTISTRUCTURAL SUPPORT SYSTEM FOR A SOLE IN A RUNNING SHOE the disclosure of which is incorporated herein by reference.

### BACKGROUND OF THE INVENTION

1. Field of the Invention

This invention relates generally to the field of shock absorbing devices for reducing anatomical shock including hiking, walking, athletic or running shoes, padding systems such as shin guards or shoulder pads and helmets, or flooring and, more particularly, to a structural support system having multiple fluid transfer and resilient structural elements to provide energy dissipation from impacts.

2. Description of the Related Art

Athletes engaging in sports of various types continue to expand the limits of their performance. Impact from running or other rapid movement trauma, body or ball contact such as in football or soccer associated sports is increasingly creating various stress or impact related injuries including concussions. Many activities are pursued by individuals in which heel strike or other foot impact including walking, hiking, running or other sports activities may contribute to repetitive stress injury or other long term complications. In sports such as football, blows to the body and head, while padded to some extent, are becoming more forceful and the potential for injury is increasing. Other sports such as soccer or lacrosse or hockey require shin guards or other padding to ameliorate strikes on the body from balls, competitor's kicks or playing implements such as lacrosse sticks or hockey sticks. In addition, potential for significant injury in activities such as motorcycling, bicycling, skiing, and other sports, requires that helmets be used for force and impulse reduction/redistribution. To allow increased endurance while reducing potential for injury sports shoes have been created which employs various structural techniques for absorbing energy to reduce impacts. Resilient mechanical elements pneumatic bladders and other elements have been employed.

It is desirable to provide a structure which adequately absorbs and dissipates impact energy that can be tailored to the activity such as walking, running, hiking or other sports in which the individual or athlete is engaged.

### SUMMARY OF THE INVENTION

The embodiments of the present invention described herein provide a shock absorbing system for impact energy dissipation, impulse modification or reduction, employing a first plurality of compressible members each having an internal void containing a first working fluid. At least one accumulator is connected to the first plurality of compressible members through a fluid conduit such that the first working fluid is transferred from the related compressible member to the accumulator responsive to compression induced by foot strike or other applied force. A flow restriction element may be associated with each fluid conduit. A pad and a liner intermediately constraining the first plurality of compressible members for integration into a shoe, sports pad or helmet.

In alternative embodiments, a plurality of resilient structural members are placed intermediate the compressible members. The resilient structural members deform responsive to compression of the foot bed induced by foot strike or other applied force, provide both energy dissipation and resilient recovery of the compression cylinders to their uncompressed state. The resilient structural members may be arcuate filaments extending from the sole pad with the arcuate members orthogonally surrounding each compressible member singly or in combination with upstanding filaments extending intermediate the sole pad and foot bed to provide a skeletal structure supporting and resiliently separating the pad and liner.

### BRIEF DESCRIPTION OF THE DRAWINGS

These and other features and advantages of the present invention will be better understood by reference to the following detailed description when considered in connection with the accompanying drawings wherein:

FIG. 1 is an isometric view partial section view showing the structural components of a first embodiment of the invention as employed in a shoe;

FIG. 2 is a top view of the embodiment shown in FIG. 1 with the foot bed removed for clarity;

FIG. 3 is a detailed partial view showing structural elements of the first embodiment of the invention including compression cylinders and arcuate resilient members;

FIG. 4 is a detailed view of a single compression cylinder and associated arcuate resilient members;

FIG. 5 is a detailed isometric view of an embodiment of the invention including a single compression cylinder and multiple resilient filaments;

FIG. 6 is an isometric view of an embodiment of the invention incorporating lateral cooling tubes in a first configuration;

FIG. 7A is an isometric view of the embodiment of FIG. 6 including a heel portion of the foot bed with the remainder of the foot bed deleted for clarity in viewing of elements of the embodiment;

FIG. 7B is an isometric view of the embodiment of FIG. 6 including a the foot bed;

FIG. 7C is an isometric view of a modified embodiment of FIG. 6 with an alternative cooling tube configuration;

FIG, 7D is an isometric view of the embodiment of FIG, 7C with the foot bed in place;

FIG. 8 is an isometric view of the details of an interrelated pair of compression cylinders with magnetic energy dissipation;

FIG. 9 is a reverse isometric view of the embodiment shown in FIG. 8;

FIG. 10 is a sectional end in view of the compression cylinder incorporating a buoyant magnet electromagnetic induction coil, impact prevention magnet, and fluid flow ports;

FIG. 11 is an isometric view of a first embodiment of a generalized shock absorbing pad employing the technology without the liner shown for clarity;

FIG. 12 is an isometric view of a second embodiment of a generalized shock absorbing pad employing the technology;

FIG. 13 is a block representation of an energy absorption system employing the embodiments of FIGS. 11 or 12 connected to an accumulator; and,

FIG. 14 is a block representation of an energy absorption system employing the embodiments of FIGS. 11 or 12 with mating cylinders acting as the accumulator.

### DETAILED DESCRIPTION OF THE INVENTION

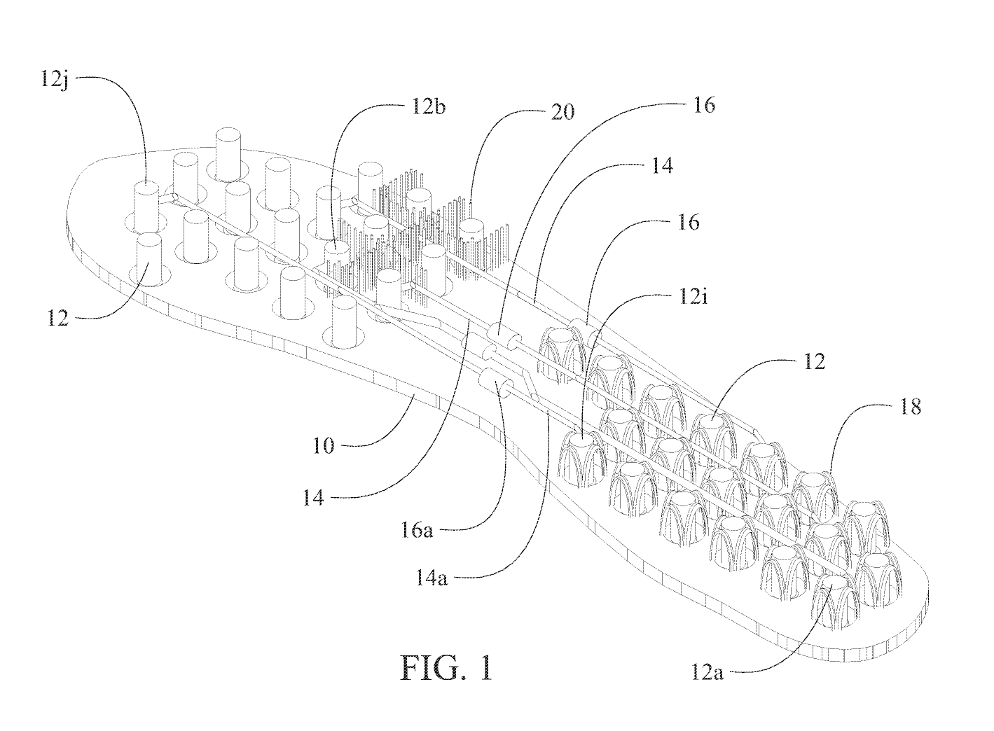

Referring to the drawings for description of the invention as utilized in a shoe, FIG. 1 shows a sole pad 10 which in various embodiments is an insert received over the sole of an athletic shoe. In alternative embodiments the sole pad is integral with the sole and may incorporate various tread designs or other features on the bottom of the pad. Compression elements shown as compression cylinders 12 constructed from resilient material such as natural or synthetic rubber and having a central void, as will be described in greater detail subsequently, extend from the sole pad upward. While shown and referred to herein as cylindrical in shape, the compression elements may be of various geometrical shapes. In an exemplary embodiment as shown in the drawings, the void in each compression cylinder is partially filled with a first working fluid leaving a compressible gas pad. In alternative embodiments, no gas working space remains in the cylinder and the walls of each cylinder are substantially collapsible when not engorged with fluid. Initial embodiments employ viscous oil as the first working fluid.

Each compression cylinder, for example cylinder 12a, is matched with a second compression cylinder, for example cylinder 12b, and interconnected with a fluid conduit 14. The number and placement of the compression cylinders is determined based on the shoe shape and desired impact absorption. For the embodiment shown multiple cylinders are placed in the heel section with matched cylinders placed in the toe section. A foot bed 11 overlies the compression cylinders encasing the support structure in combination with the sole pad. As will be described subsequently with respect to FIG. 15, compression cylinders with a central reservoir may be solely contained within the hindfoot or forefoot.

Using cylinders 12a and 12b as examples, when the wearer takes a step creating an initial heel strike transmitted through the foot bed, cylinder 12a is compressed forcing the working fluid into conduit 14a. In certain embodiments, a flow restrictor 16a regulates flow of the fluid from the compressing cylinder 12a to cylinder 12b (or an accumulator as described subsequently) as the receiving cylinder. The gas pad in the receiving cylinder is compressed, or in alternative embodiments the collapsed cylinder walls expanded, and the combination of the compression of the resilient compression cylinder 12a, fluid transfer through the restriction, and gas pad compression or cylinder wall expansion in the receiving cylinder 12b provides multiple energy dissipation mechanisms to attenuate the heel strike thereby decreasing the energy transferred back to the foot from the ground. As the wearer's foot rolls forward the process is reversed resulting in compression of cylinder 12b with resulting fluid flow through the conduit and restriction back to cylinder 12a. Energy stored in the receiving cylinder by compression of the gas pad provides a rebound effect which is recovered during the roll through of the foot thereby contributing to a reduction in effort by the athlete.

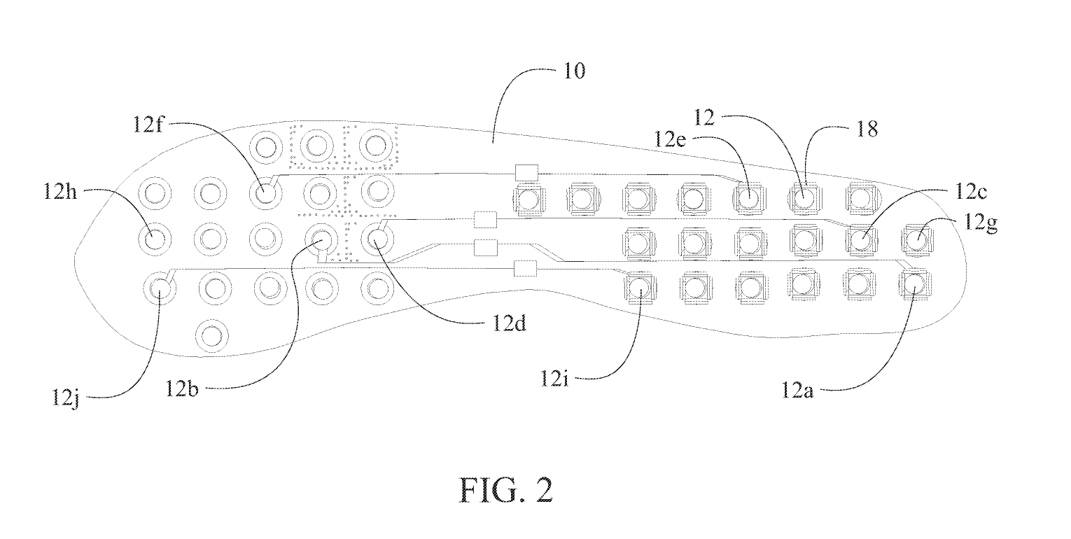

FIG. 2 shows exemplary cylinder matching pairs with associated fluid conduits. For the described embodiment of cylinders 12a, 12c 12e and 12g, are arranged in a first row immediately adjacent the heel boundary of the sole pad. Matched cylinders 12b, 12d, 12f, and 12h, are located at the ball of the foot. Cylinder 12i is located at the forward extremity of the heel portion of the sole pad with mating cylinder 12j located at the forward periphery of the toe portion of the sole pad. In a working embodiment every compression cylinder 12 is matched with a second cylinder through an associated fluid conduit 14 with optional flow restrictor 16. For the embodiment shown flow restrictor 16 is a separate element. In alternative embodiments flow restriction is accomplished by sizing of the cross-sectional area in the conduit over its length or integral forming of an orifice or nozzle in the conduit.

In order to equally distribute forces upon the chambers, durable plastic or metallic plates may be placed dorsally or volarly about the hindfoot and forefoot chambers. In addition, selective placement of cylinders may be accomplished allowing detailed control of energy transfer within the shoe structure to accommodate various pronation issues and to maximize the desired energy dissipation through maximizing the length of the fluid conduits based on the foot strike profile. For example a sprinting shoe would incorporate the matched cylinders within the toe portion of the shoe since heel strike does not typically occur. Matching of cylinders located under the ball of the foot with cylinders located under the toes would accommodate strike of the ball with roll through the toes for completion of the stride. In a distance running shoe, cross training shoe, or hiking shoe, as examples, heel strike is far more likely and matching of cylinders in the heel and toe portion provides the greatest energy dissipation. With a basketball shoe or court shoe, cylinders on the interior and exterior of the sole may be matched to accommodate torsional effects from rapid sideways motion or pivoting on the foot. Extending the compression effect over a region of the individual cylinders may be accomplished by including rigid portions or plates in the foot bed in the heel and toe regions.

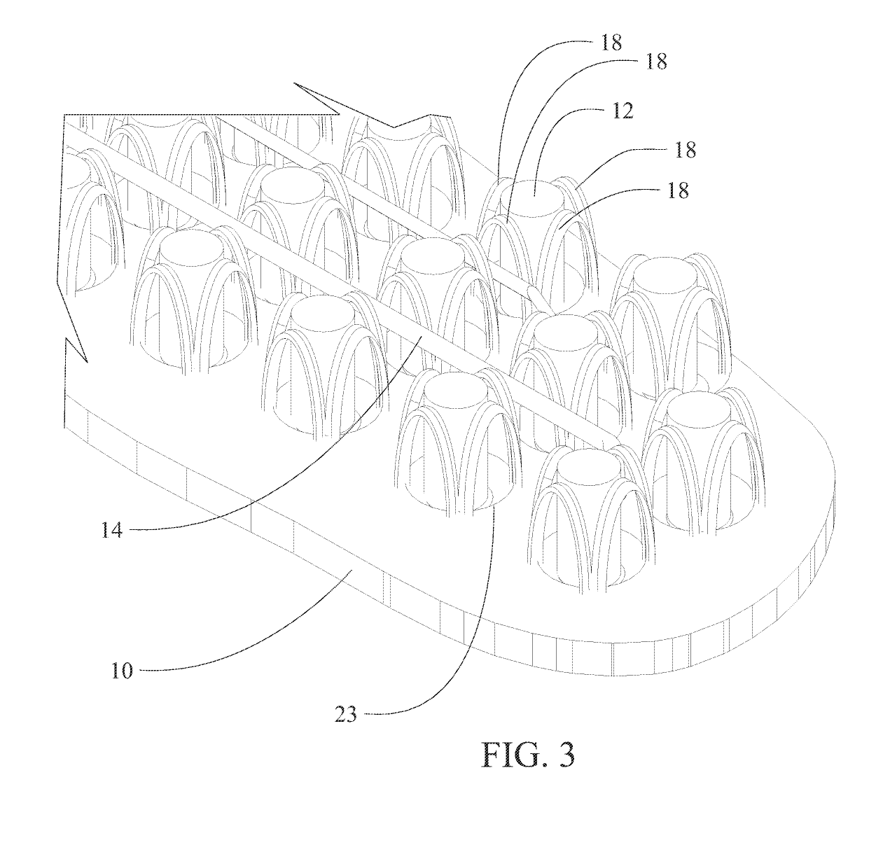

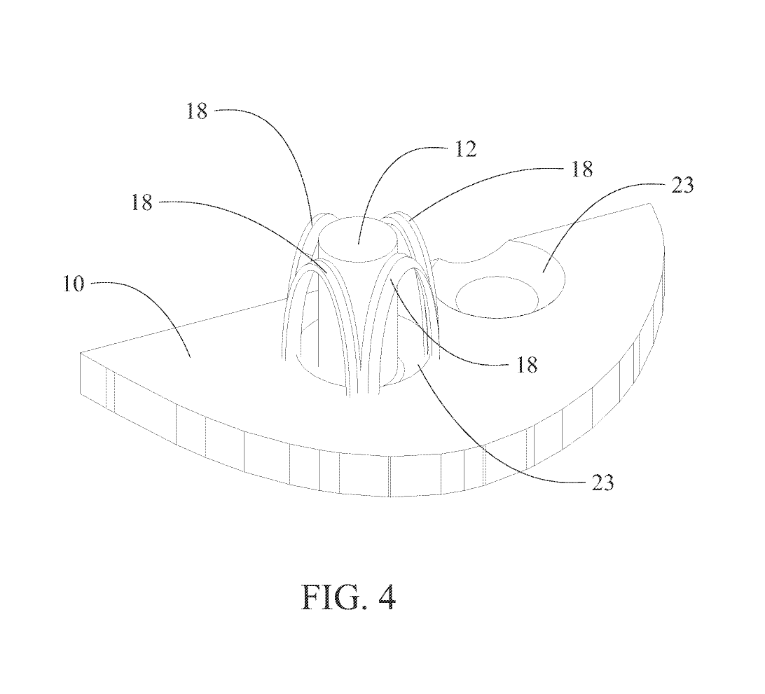

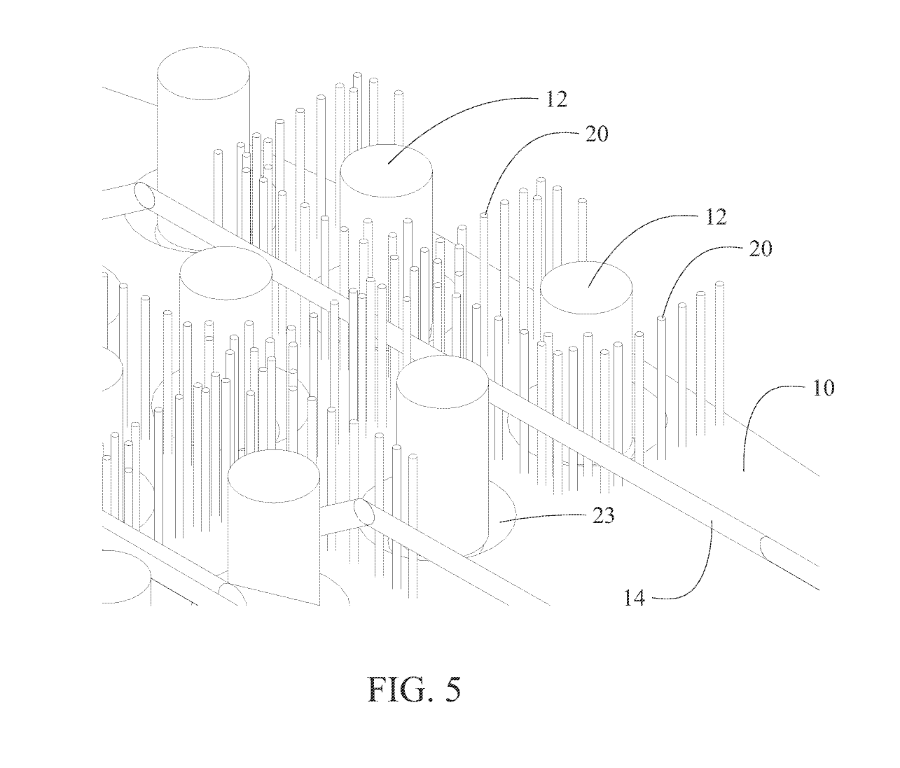

FIG. 2 additionally shows supplemental structural elements employed in the embodiment disclosed in the drawings. Additional restoring force in the resilient cylinders is provided by arcuate resilient members 18. For the embodiments shown, it is anticipated that heel strike will be the desired source for major energy dissipation and the arcuate resilient members surround cylinders in the heel area. Greater detail with respect to placement and appearance of the arcuate members is shown in FIGS. 3 and 4. For the embodiment shown each cylinder is surrounded by four orthogonally placed arcuate resilient members. The embodiment shown in FIG. 2 and FIG. 3 employs spacing of the compression cylinders with a separate set of four arcuate resilient members for each cylinder. In embodiments with regular spacing of the compression cylinders single intermediate arcuate members may be employed between adjacent compression cylinders. The arcuate members may be formed as a portion of the sole pad molding process with the cylinders and associated fluid conduits inserted intermediate the arcuate members. As additionally shown for the embodiment in the drawings, the sole pad and foot bed may employ molded depressions 23 to individually seat the cylinders.

During foot strike compression of the cylinders is accompanied by resilient deformation of the arcuate members. Upon removal of the compression force relaxation of the compressed arcuate members enhances recovery of the compressed cylinder. For the embodiment shown the arcuate members provide restoring force against a foot bed as will be described in greater detail subsequently. In alternative embodiments the arcuate members are adhesively attached or integrally formed with the compression cylinders to provide direct restoring force to the compression cylinder during relaxation of the deformed arcuate members.

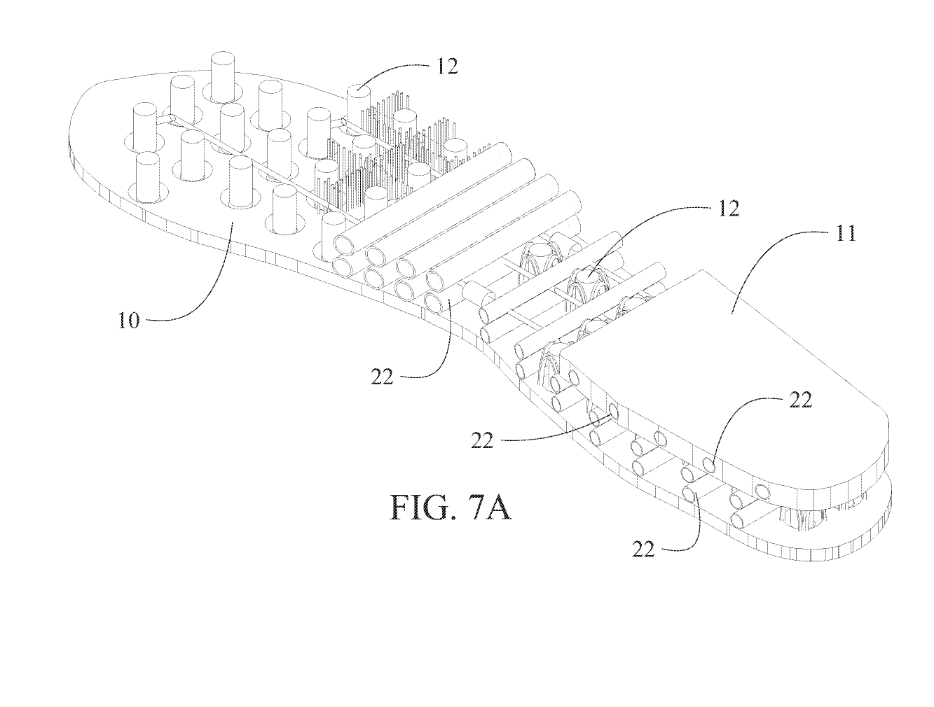

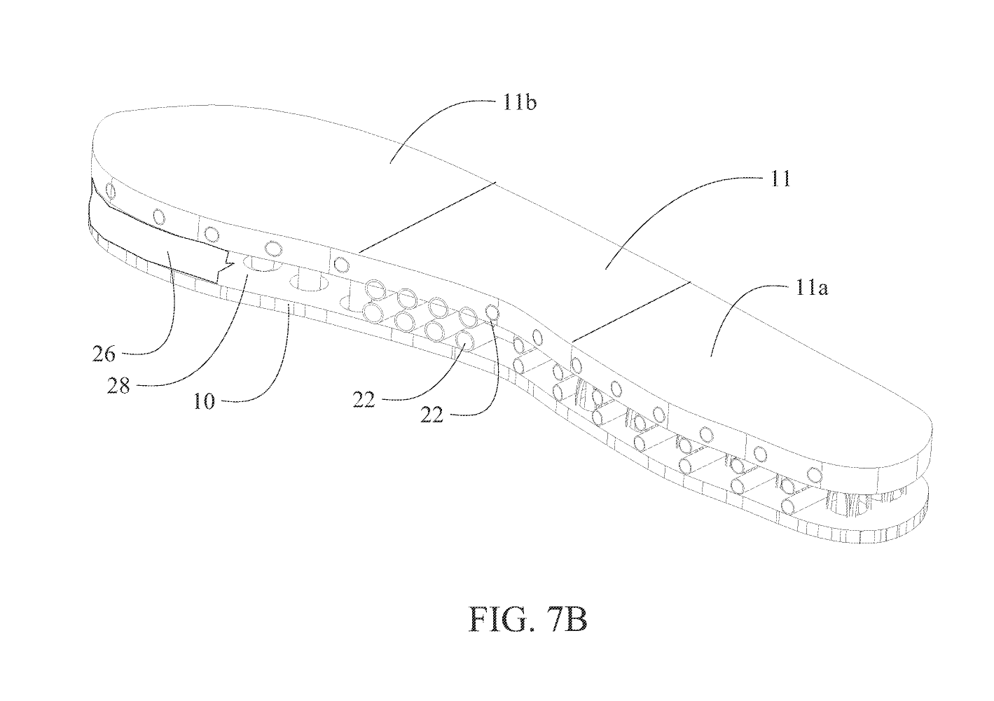

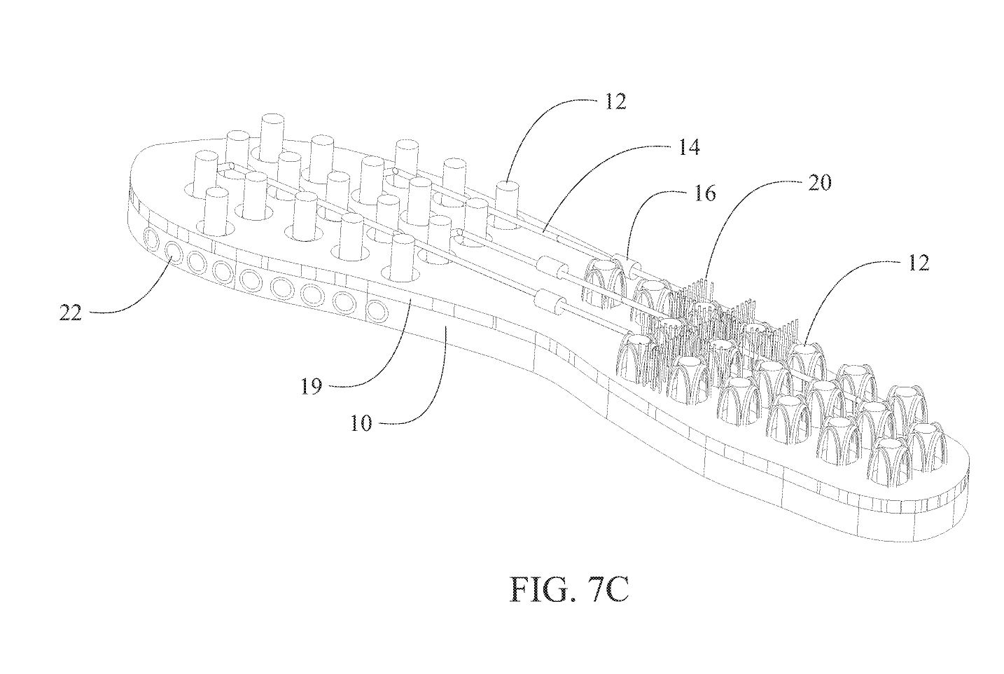

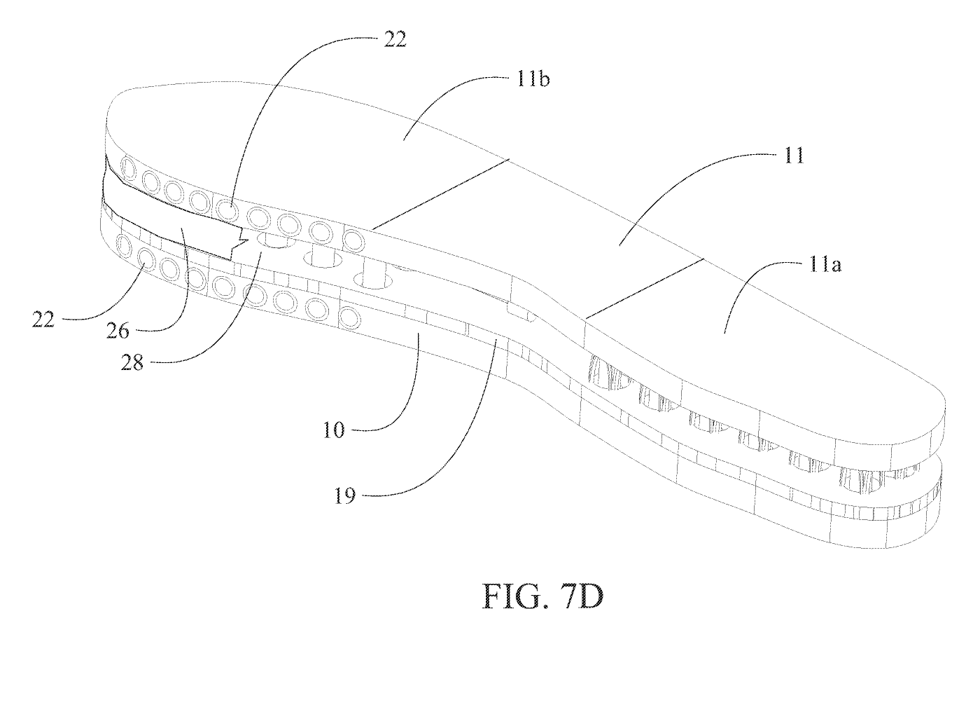

FIG. 5 shows an additional embodiment for a supplemental energy absorbing structure. Upstanding resilient filaments 20 are provided between the compression cylinders. During foot strike, deformation of the resilient filaments assists in energy dissipation and upon release relaxation of the deformed filaments provides restoring force against the foot bed as previously described for the arcuate members. While shown in FIG. 5 as present in the toe portion of the shoe, the upstanding filaments may be positioned in the heel portion as shown in FIG. 7C, which will be discussed in greater detail subsequently. In selected embodiments the upstanding filaments are used in combination with the arcuate members and may be used for providing resilient structural separation of the foot bed and sole pad intermediate compression cylinders where arcuate members are not employed. For the embodiment shown in the drawings the upstanding filaments are mounted to or integrally formed with the sole pad. In alternative embodiments the filaments may depend from the foot bed, may alternately extend from the sole pad and depend from the foot bed or constitute an interconnection between the sole pad and foot bed in a skeletal arrangement either by themselves or in combination with the compression chambers.

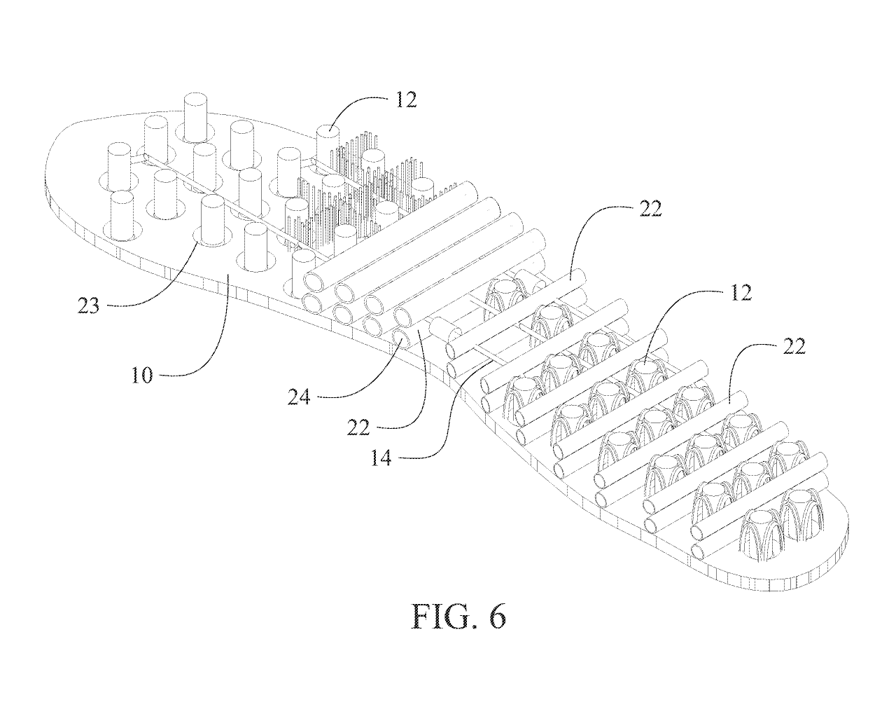

Referring to FIG. 6, cooling tubes 22 are mounted at various locations in the shoe transverse to a longitudinal axis of the sole pad. Compression and expansion of the cooling tubes during normal or walking or running action creates airflow through the open channels 24 in the tubes. Heat transfer through the transferred air allows cooling of the foot bed within the shoe for heat dissipation to the environment and continual transfer of energy from the components of the shoe to the environment. As shown in FIGS. 7B and 7D to be described in greater detail subsequently, the overlying foot bed in combination with the sole pad joined by a peripheral wall 26 provides a cavity 28 in which a second working fluid is contained. Presence of the second working fluid in the cavity additionally assists the resilient structural members in providing support similar to cerebrospinal fluid surrounding the human brain. In exemplary embodiments, purified or &ionized water is employed as the second working fluid. The working fluid is channeled between the compression cylinders, arcuate or filament resilient members, and the cooling tubes. The working fluid provides additional energy absorbing capability by flowing intermediate the various structural members during relative compression of the cavity between the foot bed and sole pad during normal walking or running motion. Additionally the working fluid, by bathing the compression cylinders, arcuate and filament resilient members and the lower surface of the foot bed, provides a conductive medium for additional heat transfer to the cooling tubes.

For the embodiments shown in FIGS. 6, 7A and 7B a portion of the cooling tubes are placed directly adjacent and in thermal contact with conduits 14 for cooling of the first working fluid transferred intermediate the compression cylinders. Additionally, cooling tubes are placed immediately adjacent, laterally or vertically, and in thermal contact with the compression cylinders for direct supplemental cooling. In one exemplary embodiment cooling tubes are integrated in the sole pad or foot bed adjacent connection locations of the compression cylinders. The portion of the foot bed shown in FIG. 7A may be a separable heel plate 11a for distribution of the force of a heel strike over the compression cylinders in the heel portion of the shoe. A comparable toe portion of the foot bed may be similarly separated from the foot bed as a whole for a similar effect in the toe portion as designated by element 11b in FIG. 7B.

FIGS. 7C and 7D show an alternative configuration of the cooling tubes in the system wherein the foot bed and sole plate in the toe portion of the shoe employ embedded cooling tubes for maximum contact and cooling of the second working fluid. Heel strike results in displacement of the fluid into the toe portion carrying energy from the compressed cylinders, fluid flow conduits and deforming resilient members. Intimate contact by the second working fluid with the top of the sole plate and bottom of the foot bed in the toe region and the placement of the cooling tubes immediately adjacent these surfaces allows maximum heat and thereby energy transfer from the working fluid to the environment by air exchange through the cooling tubes. In an advanced embodiment, a conduction plate 19 is employed in the top surface of the sole plate to enhance the heat transfer from the working fluid. While shown in the drawings only associate with the sole plate alternative embodiments employ a second conduction plate associated with the foot bed for enhanced conduction to cooling tubes in both the sole plate and foot bed.

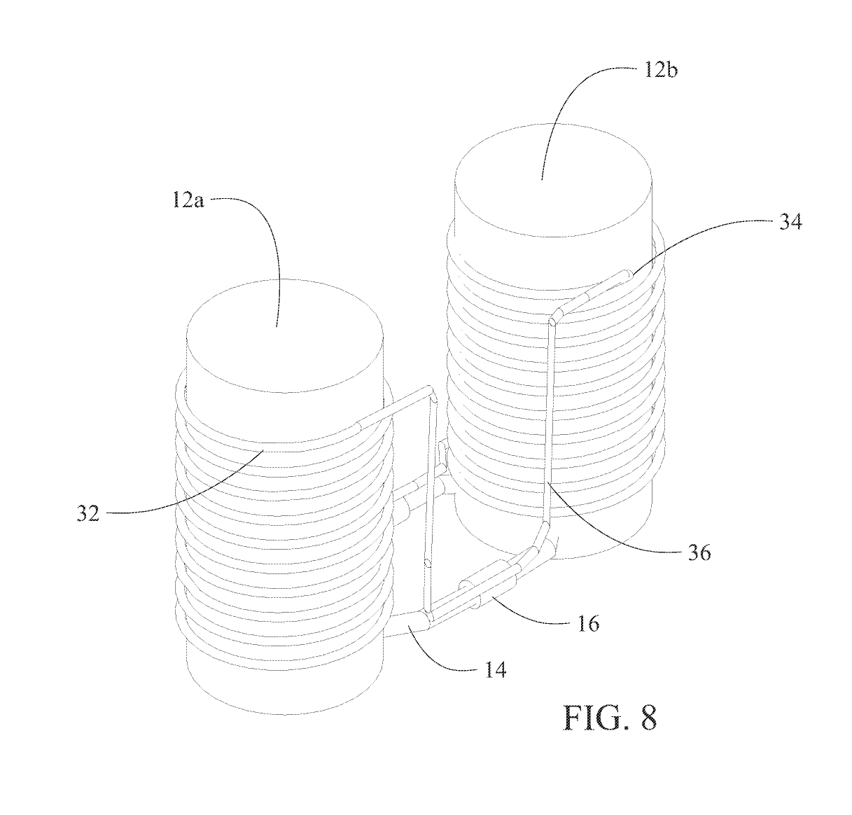

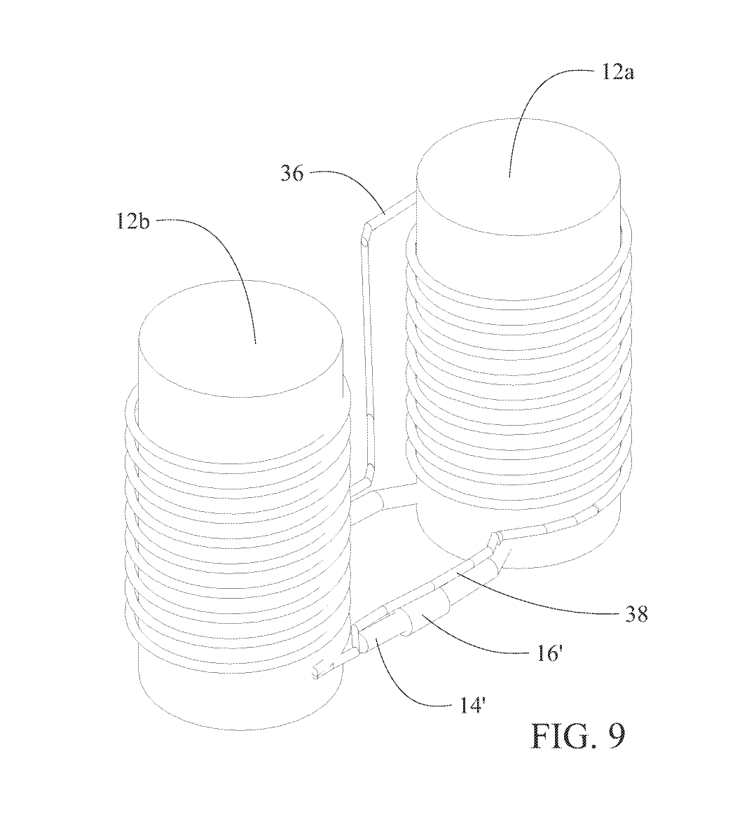

In an alternative embodiment, additional energy dissipation is accomplished through the use of an electromagnetic generation system shown in FIGS. 8, 9 and 10. A buoyant magnet 30 floats in the first working fluid of an exemplary compression cylinder 12a. An inductive pickup coil 32 is wrapped around the external surface of the compression cylinder for the embodiment shown. In alternative embodiments, the coil is encased or molded into the cylinder wall. During compression of the cylinder created by foot action as previously described the first working fluid is forced from the cylinder through conduit 14 and the magnet moves axially in the cylinder creating a current in the induction coil. Current generated is resistively dissipated as will be described in greater detail subsequently. For the embodiment shown in the drawings the mating cylinder 12b is similarly structured but incorporates an inductive coil 34 with opposite polarity to coil 32. Fluid flowing through conduit 14 and restrictor 16 urges the buoyant magnet in cylinder 12b upwardly. Interaction between the buoyant magnet in cylinder 12b and inductive coil 34 provides additional energy dissipation through a combination of both electromagnetic driving force from the current created by coil 32 and reversed EMF created by motion of the buoyant magnet. Resistance of the interconnecting wires 36 and 38 between the two inductive coils may be increased by the use of additional resistive elements. While embodiment shown in the drawings employs two coils, use of a single coil on one compression cylinder with a resistive wire loop extending from the coil provides the desired energy dissipation in alternative embodiments.

In addition, the embodiment shown in the drawings provides a parallel fluid conduit 14′ with an integral restrictive element 16′ for transfer of the working fluid the use of two conduits allows two fluid flow paths which may be associated with interconnecting electrical wires 36 and 38 respectively. Heat generated by the resistive dissipation of the induced current is transferred to the second working fluid. Intimate contact of the wires and any associated resistive elements with the fluid conduits allows enhanced heat conduction from the resistive dissipation of the electromagnetically created current. The wires are shown separate from and mounted to the surface of the conduits in the embodiments of the drawings, however, in alternative embodiments, the wires may be integrally molded into the conduit walls. As described for the embodiments of FIGS. 6 and 7 bathing of the electrical wires and first working fluid conduits in the second working fluid provides dissipation of the heat generated through the cooling tubes.

While the embodiments shown in FIGS. 8, 9 and 10 employ an induction coil integrally mounted to the compression cylinder, alternative embodiments employing a separate coil concentric with the compression cylinder. The coil may take the form of a resilient spring mounted intermediate the foot bed and a sole pad thereby providing additional energy dissipation during relative compression created by foot strike.

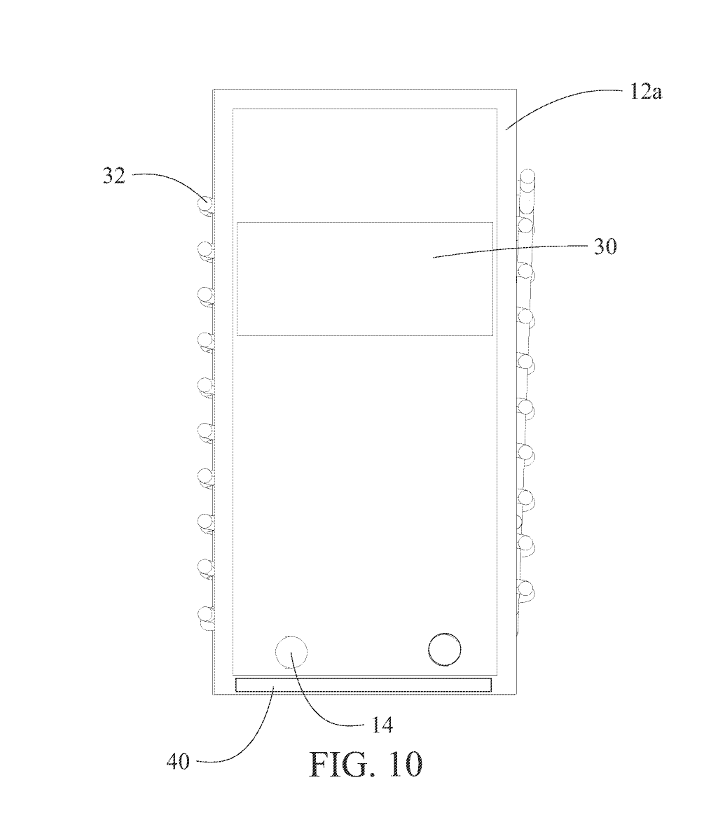

As best seen in FIG. 10, a repelling magnet 40 is mounted in the base of compressible cylinder 12a. The repelling magnet has an opposite polarity to the buoyant magnet and provides magnetic repulsion to reduce or preclude bottoming of the buoyant magnet in the compressible cylinder during foot strike. The repulsion force between the two magnets provides further energy dissipation for the foot strike compressing cylinder 12a.

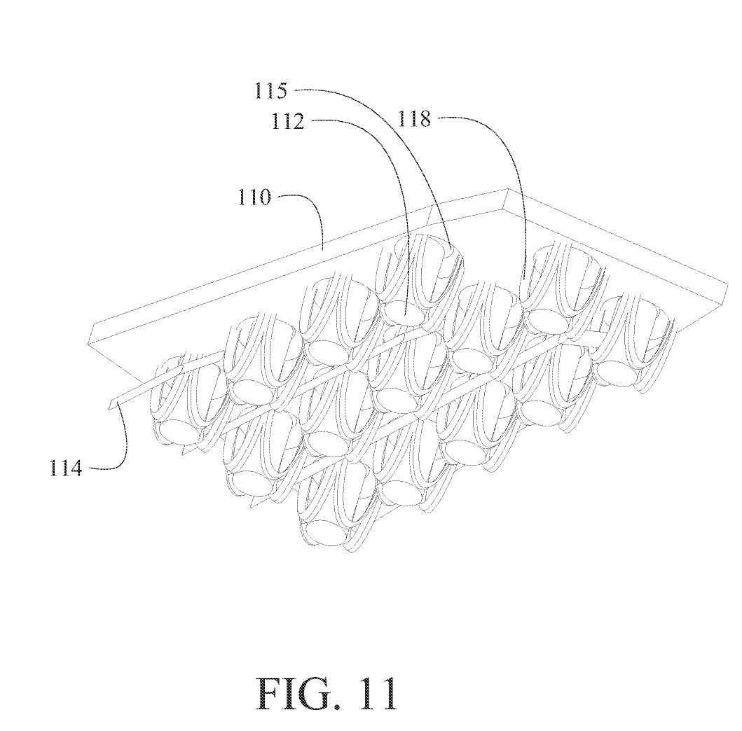

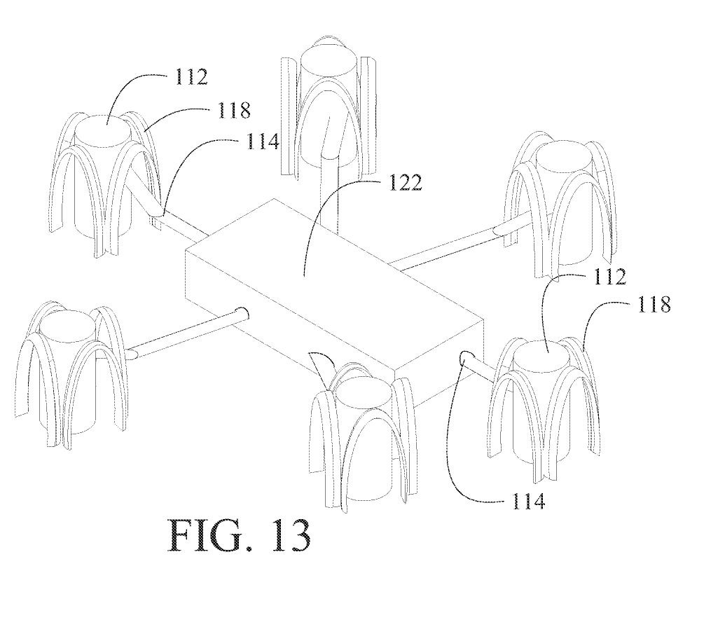

The impact absorbing capability of the present invention is employed in alternative embodiments for dissipating impact in such sports equipment as pads or helmets. As shown in FIG. 11, pad 110 which in various embodiments is a pad liner or helmet liner includes compression cylinders 112 constructed from resilient material such as natural or synthetic rubber and having a central void, as previously described with respect to the shoe embodiments of the invention, extend from the pad. In an exemplary embodiment as shown in the drawings, the void in each compression cylinder is partially filled with a first working fluid leaving a compressible gas pad. In alternative embodiments, no gas working space remains in the cylinder and the walls of each cylinder are substantially collapsible when not engorged with fluid. Initial embodiments employ viscous oil as the first working fluid. Fluid conduits 114 extend from each pad for transport of the working fluid as will be described in greater detail with respect to FIG. 13.

Additional restoring force in the resilient cylinders may be provided by arcuate resilient members 118. For the embodiment shown each cylinder 112 is surrounded by four orthogonally placed arcuate resilient members. The embodiment shown employs spacing of the compression cylinders with a separate set of four arcuate resilient members for each cylinder. In embodiments with regular spacing of the compression cylinders single intermediate arcuate members may be employed between adjacent compression cylinders. The arcuate members may be formed as a portion of the pad molding process with the cylinders and associated fluid conduits inserted intermediate the arcuate members. As additionally shown for the embodiment in the drawings, the pad may employ molded depressions 115 to individually seat the cylinders.

During impact against the pad, compression of the cylinders against the protected body part (or an inner liner shown as the foot bed in the shoe embodiments) causes fluid displacement through the fluid conduits and is accompanied by resilient deformation of the arcuate members. Upon removal of the compression force relaxation of the compressed arcuate members enhances recovery of the compressed cylinder. For the embodiment shown the arcuate members provide restoring force against a liner as will be described in greater detail subsequently. In alternative embodiments the arcuate members are adhesively attached or integrally formed with the compression cylinders to provide direct restoring force to the compression cylinder during relaxation of the deformed arcuate members.

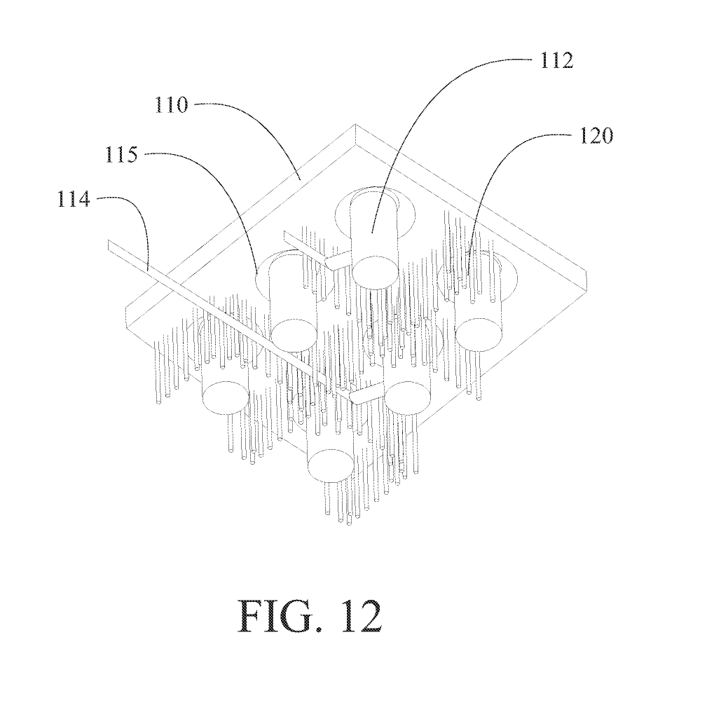

FIG. 12 shows an additional embodiment for a supplemental energy absorbing structure. Upstanding resilient filaments 120 are provided between the compression cylinders. During impact, deformation of the resilient filaments assists in energy dissipation and upon release relaxation of the deformed filaments provides restoring force against the liner as previously described for the arcuate members. In selected embodiments the upstanding filaments are used in combination with the arcuate members and may be used for providing resilient structural separation, integrity and support of the liner and pad intermediate compression cylinders where arcuate members are not employed. For the embodiment shown in the drawings the upstanding filaments are mounted to or integrally formed with the pad. In alternative embodiments the filaments may depend from the liner, may alternately extend from the sole pad and depend from the liner or constitute an interconnection between the pad and liner in a skeletal arrangement.

As shown in FIG. 13, the conduits 114 extending from the cylinders 112 are routed to an accumulator 122. For the embodiment in the drawing a single accumulator is used, however, multiple accumulators may be employed. The accumulator may be rectangular, cylindrical (with circular or ovoid cross section) or other appropriate geometric shape. The previously described shoe embodiments allow transfer of fluid between cylinders in differing locations in the sole to allow for rock through in stepping motion or similar processes to transfer fluid between cylinders. In many applications, alternating impact or pressure on differing regions of the pad may not be present and after an impact, replacement of the working fluid in the cylinders is required. Use of the pressurized accumulator to receive working fluid from the compressing cylinders during impact then allows expulsion of the fluid from the accumulator back into the cylinders after resolution of the impact for refilling in preparation for subsequent impact events. In a helmet embodiment as an example, the accumulator could be placed at the nape of the neck on the helmet rim to receive fluid from cylinders spaced throughout the helmet. An example accumulator may employ a pressure cylinder with an inner bladder connected to the conduits. A pressure pad of inert gas such as nitrogen may then be provided between the pressure cylinder and bladder. In the prior disclosed embodiments for the shoe structure, the cylinders distally located from the impact absorbing cylinders act as the accumulators and pressure provided on those cylinders by the foot roll through creates pressure for the reversing flow.

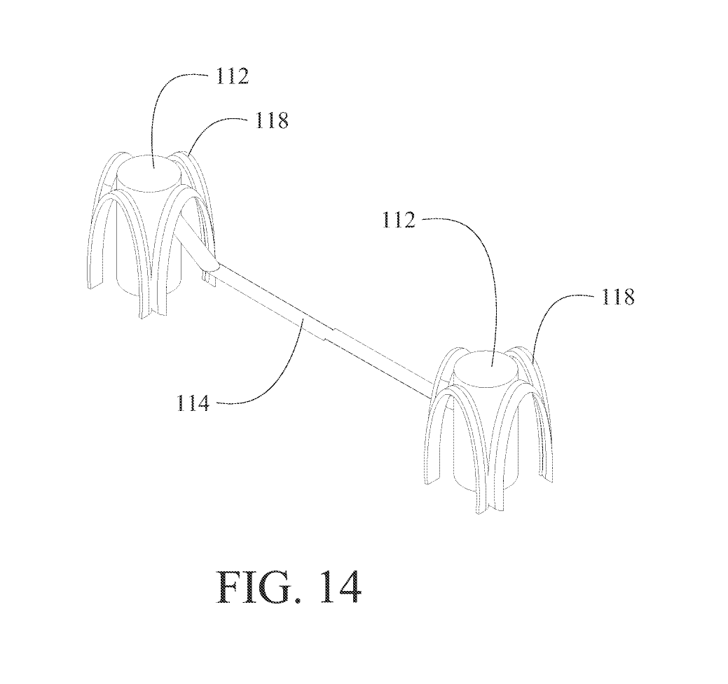

In alternative embodiments as shown in FIG. 14, the conduits 114 may interconnect cylinders in differing locations on the pad which are unlikely to have simultaneous impact and the cylinder material is sufficiently flexible to allow expansion of the cylinder not in the impact zone to accommodate fluid flowing from the impacted cylinder(s). Resilient contraction of the expanded cylinder(s) then forces the working fluid back through the conduit to expand the cylinder(s) compressed by the impact. As described with respect to the representative shoe embodiments, a second working fluid surrounding the chambers, conduit tubing, filaments, pillars and accumulator may or may not be employed.

For the embodiments described, numerous cylinders can be placed in a circumferentially dispersed manner about a central reservoir acting as the accumulator with conduits connecting each cylinder with the reservoir. Filaments, either arcuate or pillar in form, as previously described, may be placed around the cylinders and/or reservoir. Upon compression by an applied force, the cylinders will displace fluid through the conduits into the central reservoir. The filling and expansion of the central reservoir will crate a positive pressure which will assist in refilling the cylinders upon removal of the force. In addition, the intrinsic recoil of the cylinders as well as the surrounding filaments, if used, will help to re-expand the cylinders. The arrangement of the overall pattern may be circular, rectangular or any other desired shape. As shown in FIG. 13, the central reservoir is of lesser height and as the volume of displaced fluid increases, the pressure in the reservoir increases. The reservoir and chambers can be of any desired size. Multiple grouping of cylinders and reservoirs, subsequently referred to herein as cells, may be employed. Plates, such as the liner in previously described embodiments, may be employed above or below, or both, the cells to equally distribute the applied force. The cells may be replaceable, individually or as a sheet, after repetitive impulses. The cells may or may not be surrounded by a second working fluid as previously described for additional absorptive properties similar to cerebral spinal fluid surround the human brain.

As an additional means to restore the first working fluid to the chambers, for example in a helmet, the central reservoir can be pushed by the fingers after removal of the helmet. The location of the reservoirs can be made conspicuous. Finally, for each of the embodiments, the fluid contained in the cylinders may be radioopaque to allow easy determination with a simple x-ray of whether the structural integrity of the cylinders, conduits or accumulators has compromised and fluid is leaking. If disrupted, the cell or cells, if in a sheet, can be replaced. This approach can be employed with ay type of helmet including football, hockey, skiing, motorcycle, race car, etc.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A shock absorbing system for impact energy dissipation comprising:
a pad;
a first plurality of compressible members extending from the pad each having an internal void containing a first working fluid;
at least one receiving accumulator connected to the first plurality of compressible members through a plurality of fluid conduit, said first working fluid transferred at least one compressible member to the at least one accumulator responsive to compression of the at least one compressible member induced by an impact.

2. A shock absorbing system as defined in claim 1 farther comprising a flow restriction element associated with said fluid conduit.

3. A shock absorbing system as defined in claim 1 wherein the pad comprises a sole pad for a shoe and further comprising afoot bed intermediately constraining the first plurality of compressible members and the at least one accumulator comprises a second equal plurality of mating compressible members.

4. A shock absorbing system as defined in claim 1 further comprising a plurality of resilient structural members intermediate said the compressible members, said resilient structural members resiliently deforming responsive to compression of the pad induced by an impact.

5. A shock absorbing system as defined in claim 4 wherein the resilient structural members comprise arcuate filaments extending from the pad.

6. A shock absorbing system as defined claim 5 wherein the arcuate members orthogonally surround each compressible member.

7. A shock absorbing system as defined in claim 4 wherein the resilient structural members comprise upstanding filaments extending intermediate said sole pad and a liner.

8. A shock absorbing system as defined in claim 3 further comprising a plurality of the cooling tubes transversely extending intermediate said pad and liner.

9. A shock absorbing system as defined in claim 4 wherein the pad and liner are interconnected by a peripheral wall forming a cavity and further comprising a second working fluid contained in said cavity and transmissible intermediate said the compressible members responsive to compression of the liner responsive to an impact.

10. A shock absorbing system as defined in claim 9 further comprising a plurality of cooling tubes transversely extending through the cavity for cooling of said second working fluid.

11. A shock absorbing system as defined in claim 9 wherein the second working fluid bathes the compressible members, conduits and flow restriction elements for heat transfer.

12. A shock absorbing system as defined in claim 1 wherein the working fluid is radioopaque.
